(19) United States
(12) Patent Application Publication
(10) Pub. No.: US 2021/0198136 A1
(43) Pub. Date: Jul. 1, 2021

(54) COMBINATORIAL MEMBRANE-BASED SYSTEMS AND METHODS FOR DEWATERING AND CONCENTRATING APPLICATIONS

(71) Applicant: Jigar JANI, Usmanpura (IN)

(72) Inventor: Jigar JANI, Usmanpura (IN)

(21) Appl. No.: 17/274,171

(22) PCT Filed: Oct. 27, 2018
(86) PCT No.: PCT/IN2018/050694

§ 371 Date: Mar. 23, 2021

(30) Foreign Application Priority Data
Sep. 7, 2018 (IN) 201821033675

(51) Int. Cl. C02F 9/00; B01D 61/58; B01D 61/00; B01D 71/56; B01D 71/16; B01D 61/02; B01D 61/36

(52) U.S. Cl. CPC C02F 9/00; B01D 61/58; B01D 61/002; C02F 2103/08; B01D 71/16; B01D 61/022; B01D 61/364; B01D 71/56

(57) ABSTRACT

This invention relates to various membrane-based processes and their combinations, such as Forward Osmosis (FO), Reverse 5 Osmosis (RO), Nanofiltration (NF), Ultrafiltration (UF), Membrane Bioreactor (MBR), Osmotic Distillation (OD) and Membrane Distillation (MD), for various application of dilution, concentration, dewatering, separation, purification, fractionation or extraction applications of different solvents including 10 various sources of water, wastewater, active pharmaceutical ingredients (APIs), food and beverage sources, dairy products etc. It is also applicable to all the industrial and domestic applications that involves recovering or water reclamation from inlet sources.

This application claims priority to India invention application number 201621037576 filed on 3 Nov. 2016

### FIELD OF INVENTION

This invention relates to various membrane-based processes and theft combinations, such as Forward Osmosis (FO), Reverse Osmosis (RO), Nanofiltration (NF), Ultrafiltration (U F), Membrane Bioreactor (MBR), Osmotic Distillation (OD) and Membrane Distillation (MD), for various application of dilution, concentration, dewatering, separation, purification, fractionation or extraction applications of different solvents including various sources of water, wastewater, resource recovery, active pharmaceutical ingredients (APIs), food and beverage sources, dairy products etc. It is also applicable to all the industrial and domestic applications that involves recovering or water reclamation from inlet sources.

### BACKGROUND OF THE INVENTION

In an increasing water stressed world, it is even more important to recover and recycle water from waste sources. In order to achieve high water sustainability in the face of depleting fresh water sources, it is even more important to recycle all sorts of wastewater. Additionally, stringent environmental regulations are forcing wastewater emitters to consider brine minimization or Zero Liquid Discharge (ZLD) approach which essentially recovers all water from waste sources such that there will not be any effluent stream generated. The brine minimization/ZLD system in its final stage involves thermally operated evaporation system that converts all dissolved salts into powder form which was eventually landfilled. Current membrane technologies (RO, NF) to recover wastewater for reuse purpose have theft own limitations at high salt concentration (>35000 mg/l) such as high energy costs, demanding maintenance, complex operational footprint and the fouling of membranes. Moreover, if the wastewater contains high chemical contaminants, inorganics, biological load, and other constituents, it will require rigorous pretreatment before being subjected to RO/NF membranes. This in turn leads to complex additions of multiple pretreatment stages driving high capital and operational costs.

The concentrated feed source, wastewater reject stream or brine resulting from of RO/NF system is extremely high and often cannot not be directly disposed to immediate environment due to regulatory compliance and adverse effects on natural habitat. Therefore it is further subjected to evaporator and crystallization system to recover more water and remove salt in a precipitated powder form.

Typical RO brine contains 5-7% of salt concentration which is directly fed to multi-stage evaporator. For such brine stream, evaporator and crystallization system consumes extremely high amount of energy and incurs high capital and operational costs. For example, multi-stage evaporator system consumes around 150-230 MJ per m3 of product water.

Often due to corrosive nature of brine stream, evaporator and crystallization systems are constructed with expensive metals. The corrosion depends on the concentration of dissolved gases, operating temperature, pH and total chlorides in brine stream.

Typically prior to feeding to evaporator system, the feed is deaerated, pH adjusted and anti-scaling chemicals are added to control the precipitation of calcium carbonate, calcium sulfate and magnesium hydroxide.

If RO brine contains high concentration of COD, hardness and scaling precursors, it will create additional problems of scaling on internal walls of evaporator which ultimately leads to reduced energy efficiency, high maintenance costs, low operational efficiency and decreased plant uptime.

Therefore, there are several approaches to treat and recycle wastewater depending on the influent water quality and end use. Mostly, these approaches consist multiple steps and stages involving many individual unit operations. This may include but not limited to multimedia filtration, activated carbon adsorption, chemical softening, ion exchange units, cartridge filtration, micro/ultrafiltration, nanofiltration and reverse osmosis.

However, use of above technologies involves huge capital investment and high operational and maintenance (O&M) costs. Additionally, several industrial applications involve concentrating feed source to highest possible solute/constituent concentration which is typically achieved using thermally intensive evaporation and crystallization processes. In many situations, specifically for food and beverage industry, thermal processes tend to pose even a bigger challenge of denaturation of natural constituent or loss of aroma and fragrance.

Therefore, it is necessary to develop and invest in a technology that has overall lower asset footprint, low chemical usage, effective feed treatability, low fouling and scaling tendency, low operation and maintenance costs, modest operating conditions, high water recovery and longer membrane lifetime.

### SUMMARY OF THE INVENTION

The embodiments of the present disclosure covers forward osmosis membrane process with individual as well as various combination of conventional membrane-based processes such as microfiltration, ultrafiltration, nanofiltration, reverse osmosis, membrane distillation, membrane bioreactor, pervaporation, gas-liquid contactors etc. They specifically provide solutions for purifying a feed source, such as removal or separation of chemical constituent, ions, solutes, salts or suspended solids.

The benefits of combining forward osmosis process with other membrane filtration processes are many such as;
the FO process is naturally occurring and thus requires no external energy input
effective pre-treatment to high pressure RO/NF or high temperature MD operation-mainly due to incorporation of draw solution, its recovery of product water and regeneration of draw solution eliminates often harmful multicomponent feed contaminants interaction with RO, NF or MD to rather easy and simple binary interaction of draw solutes
low pressure operation significantly reduces the complex issue of fouling and scaling even for some of the most complex wastewater
membrane cleaning regime and membrane lifetime improved

One of the particular application is purification of saline water including sea water, brackish water, industrial wastewater, impaired water or other water sources.

In another particular example, the liquid to be treated was chemical industry contaminated wastewater containing high amount of organics, TDS, hardness, suspended solids, biological compounds, ions etc. The wastewater is to be treated for recycle purpose to be used back again in the process industry.

In a separate example, the liquid is cooling tower and boiler blow-down water from power industry.

Another example was wastewater from electroplating industry containing high heavy metals, organics, dissolved ammonia, color etc. The recycled water is further utilized to improve water sustainability.

In an another example, the wastewater from mining industry containing high levels of hardness and suspended solids is subjected to purifying system to reduce the contamination levels to allow surface discharge of treated effluent.

In further example, the methods, processes and systems described in this invention disclosure are used for the purification of wastewater or spent wash water from distillery and sugar industry.

In an another example, food processing and beverage industries benefited from the systems described in this invention to dehydrate, dilute, concentrate or to produce nutrient streams for various sources such as fruit juices, beverages, alcohol, milk, milk whey, cheese brine, spices concentrate, food fragrances etc.

In further example, pharmaceutical industry benefits from concentrating and purifying active pharmaceutical ingredient (API) by improving product quality.

In a separate example, the produced water of brackish and saline water characteristics during the extraction of oil and natural gas can be effectively treated, recycled and reused by combination of membrane processes described in this embodiment.

In a separate example, textile, dyes and intermediate industry utilized the methods and system described in this disclosure to further concentrate multi-stage reverse osmosis (RO) brine to reduce brine volume by increasing its concentration so that it further reduces capital and operational costs of multi-stage evaporator and crystallization unit. It also benefitted in achieving zero liquid discharge (ZLD) to obtain water sustainability goals.

In one of the example, the brine from seawater desalination was subjected to system described in this invention disclosure to further increase brine salt concentration so that concentrated brine can be used in chlor-alkali industry or it can be further subjected to resource recovery/mining processes to obtain precious minerals or elements. In a further example, the diluted salts such as sodium sulfate, magnesium chloride, calcium chloride, magnesium sulfate etc were further concentrated from 4-5% (w/w) to 20-22% (w/w).

In a separate example, the use of pressure-retarded osmosis for the generation of electricity by isolating saline and fresh water by FO membrane.

Moreover, though the present disclosure primarily aims for purifying and separating water, there might be other application areas involving separation and purification of other solutes-solvents, where the methods and systems described in this disclosure can be implemented.

### Background and Objective

Pressure-driven processes such as NF or RO to remove salts from saline water has seen significant improvement in terms of membrane module design, fouling behavior and costing in past couple of decades. Apart from that, NF or RO operation offers distinct advantages of simple operation, robustness and flexibility. However, low water recovery, high energy usage, membrane fouling and scaling and low membrane life remains to be major issues for RO systems that prevents standalone RO system to achieve higher sustainability.

Contrary to NF or RO, forward osmosis (FO) is a naturally occurring osmosis process in which osmotic pressure gradient typically occurs across all semi-permeable membrane N. In such systems, FO membrane separates feed side and concentrated solute side called “draw solution”. The product water from feed side flows across the membrane to draw solution side purely by diffusion (without the need of extra pressure or energy) until the solute concentration on both sides of the membrane becomes equal.

Similar to NF or RO membranes, forward osmosis (FO) membranes reject organic components, salts, ions, minerals and other particulates from feed stream. In addition, and more importantly, they offer advantages in terms of significantly less energy usage and minimal fouling of membranes.

However, after recovery of product water from feed stream into the draw solution stream, it is important to recover product water in the second stage draw solution recovery process. The recovery stage process selection mainly depends on draw solute, diluted draw solution concentration, desired water recovery, product water quality and regulatory compliance etc.

Although attempts have been made in the past for application of FO technology for low as well as high salinity water [2], it was mainly limited to the applications of desalination of brackish or sea water using direct pass Reverse Osmosis membrane systems (FO-RO system) for draw solution recovery. Even though FO-RO system is effective in treating and recovering water from varied sources at low salinity levels [3], it is still a big challenge to effectively recover water from highly saline source water. Additionally, overall system requirement to effectively recover entire product water from diluted draw solution and completely regenerate draw solution is still a big challenge mainly due to high energy requirement, hydraulic pumping pressure limitations, system complexity and feasibility of commercially available RO membrane at high osmotic pressures. Due to these limitation, current FO-RO system is capable to achieve brine concentration only in the range of 120,000 to 140,000 ppm TDS (12 to 14% wt/wt) which limits the applicability of FO-RO process for highly saline streams.

Similarly, recent developments in FO-MD system mainly focuses on the study of operational and process parameters of FO and MD system individually or combined to gain insight into wastewater recovery or sea water desalination [4]. However, there are still gaps in understanding the influence of draw solutes, alternative feed source, membrane configuration or multiple combinations of membrane processes of FO, RO, MD on overall treatment objectives.

This patent disclosure covers the approach of employing various combinatorial membrane systems, process parameters and methods to achieve Maximum Brine Concentration (MBC) up to the salt concentration in the range of 18%-25% wt/wt. This invention describes more advanced sustainable process combinations of implementing FO with various configurations of draw solution recovery units of UF, NF, high brine RO, BWRO, SWRO, Osmotic-RO, MD and Osmotic Distillation that exploits benefits of technologies to offer following advantages:
High water recovery
Simple, easy and integrated design
Minimized waste
Low energy consumption per unit of water recovered
Low capital investment
Low operation and maintenance costs
Modular structure

This invention describes different configurations of multistage FO and draw solution regeneration processes that includes optimized operating and process conditions to give high water recovery, low energy consumption, less draw solution leakage, high productivity and low O&M expenses per unit of water recovered or extracted. This approach will enable the end-user to achieve more than 75% of water recovery and 50% reduction in energy consumption.

Our hybrid FO and combined recovery of unit membrane processes of UF, NF, RO or MD can be easily up-scaled or applied to other applications such as industrial wastewater, impaired water, brackish or sea water desalination, fruit and beverages concentration, milk solids concentrates etc. in order to increase sustainability that improves overall water and energy efficiency that has positive impact on global challenges of climate change, energy costs and public health.

Process

The present invention disclosure is covering the system that purifies and recovers liquid stream, such as various water sources for example industrial or household wastewater, seawater, brackish water, impaired water or any source that needs to be dewatered or concentrated such as aqueous chemical solution, biological stream, food and beverage source, pharmaceutical solution.

In a specific situation, the water source is industrial wastewater effluent which is subjected to water purification system as described in this invention disclosure and contains high concentrations of salts, ions, organics, inorganics, biological compounds, suspended solids etc. The water purification system in combination with prior pretreatment stages undergoes forward osmosis units followed by other arrays of conventional membrane systems, or in combination of several sub-systems, such as MF, UF, NF, RO, MD, MBR etc.

The forward osmosis unit operates with two separate streams entering the unit, one containing feed liquid source or feed water stream and other being high osmotic pressure stream than feed stream (“draw solution”).

The draw solution is either synthetically made or naturally available source and contains sufficiently high salt concentration that draws product water from feed stream. They can be natural inorganic salts such as sodium chloride, calcium chloride, magnesium chloride, potassium chloride, ammonium bicarbonate etc. or natural organic source such as glucose, sucrose, fatty acid, glycol, organic salt etc. Synthetically made draw solution can be organic salts, molecules such as sodium polyacrylates dendrimers, polymer hydrogel, ammonia-carbon dioxide, thermosensitive polyelectrolytes, switchable polarity solvents, sodium salt of EDTA, Zwitterions (i.e. glycine, L-proline, glycine betaine) etc.

Ideally draw solution should offer high osmotic pressure, low reverse solute flux, low viscosity and low toxicity with high suitability with overall system, economic and environment friendly. One of the most important factor for draw solution selection is easy regeneration after FO process so that entire FO system gives overall low energy requirement, low footprint, low capital and operational investment and high water flux.

In FO system, draw solution having high osmotic pressure compared to feed stream triggers instantaneous flux of pure water molecules across the forward osmosis membrane from feed compartment to draw solution compartment. The dewatered or concentrated feed exits the system as a waste or reject stream while diluted draw solution is subjected to further recovery process containing any of the membrane processes such as MF, UF, NF, RO, MD etc or their combinations thereof.

In many of the examples where high salinity brine requires to be effectively treated and recycled include combination of multi-stage of forward osmosis system together with multiple arrays of draw recovery membrane units of microfiltration, ultrafiltration, nanofiltration, reverse osmosis or membrane distillation. One of the preferred method of draw solution recovery is first few stages of high rejection nanofiltration followed by high salinity sea water reverse osmosis membrane units.

There are number of approaches presented in this invention to recover draw solution. More commonly in all approaches, in the first stage, this invention presents pressure-driven operation consisting of mainly multistage nanofiltration and reverse osmosis units. Typical pressure requirement of nanofiltration units are ranging from 20 to 40 bar and for reverse osmosis units are ranging from 55 to 70 bar.

Recently there are development of new NF or RO membranes that are capable of treating high-salinity feed streams with relatively high hydraulic pressure of 120 bar. In this invention disclosure, a novel approach of Counter-currently or Co-currently fed single or multi-stage Sweep solution assisted Osmotic NF (CSONF) or RO (CSORO) system that takes assistance from additional synthetic high osmotic pressure sweep solution on the permeate side to gain the benefit of net lower osmotic pressure across the NF or Brine Water (BWRO) or Sea Water RO (SWRO) membrane to recover water at relatively lower hydraulic pressure. The stages of draw solution recovery of high pressure system could be various combinations of NF or BWRO or SWRO membrane system.

For example, in one specific application scenario, there may be a combination of sweep solution assisted osmotic NF as first stage to dilute draw solution further and followed by multiple direct pass BWRO as subsequent stages to recover product water directly from draw solution.

In another example there are alternative stages of NF and SWRO membrane systems until final draw solution concentration is achieved and entire volume of FO product water is recovered. In general, there can be any form of combinations with which high pressure NF or RO stages are to be arranged and this invention disclosure proposes to cover any set of NF or RO or their combinations in parallel or series configuration.

### BRIEF DESCRIPTION OF THE DRAWINGS

It will be convenient to further describe the present invention with respect to the accompanying drawings that illustrate possible arrangements of the invention. Other arrangements of the invention are possible, and consequently the particularity of the accompanying drawings is not intended to be limiting

FIG. 1 represents schematic diagram of multi-stage and multi-pass Forward Osmosis (FO) process in combination of Counter-currently operated Sweep solution assisted Osmotic Reverse Osmosis system (CSORO).

FIG. 2 Schematic of hybrid Forward Osmosis process of RO-FO-NF in series

FIG. 3: Schematic of hybrid Forward Osmosis process of FO-RO with FO reject fed to NF system

FIG. 4: Schematic of hybrid Forward Osmosis process of FO-NF-NF

FIG. 5: Schematic of hybrid Forward Osmosis process of FO-MD

FIG. 6: Schematic of hybrid Forward Osmosis process of NF-FO-MD

FIG. 7: Schematic of hybrid Forward Osmosis process of NF-FO-NF

FIG. 8: Process Instrumentation and Control Diagram (P&ID) of Forward Osmosis-Membrane Distillation Setup as outlined in FIG. 5

FIG. 9: Process Schematic of FO and heat integrated MD unit under optimized conditions

### DETAILED DESCRIPTION OF THE INVENTION

Before explaining the present invention in detail, it is to be understood that the invention is not limited in its application to the details of the construction and arrangement of parts illustrated in the accompanying drawings. The invention is capable of other embodiments, as depicted in different figures as described above and of being practiced or carried out hi a variety of ways. It is to be understood that the phraseology and terminology employed herein is for the purpose of description and not of limitation.

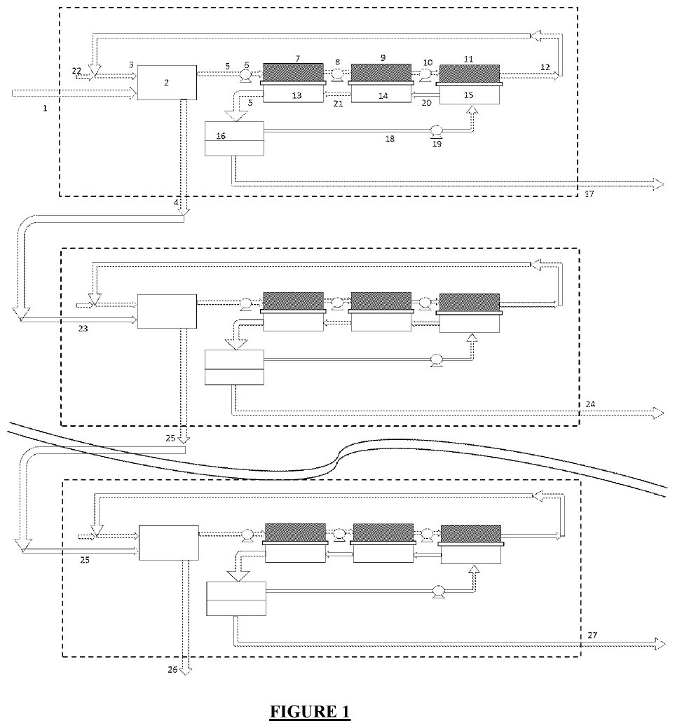

FO membrane system will have diluted draw solution mixed with product water and entering into draw solution regeneration units. This patent disclosure reveals novel method of draw solution regeneration using multi-stage and multi-pass Counter-currently (or Co-currently) fed Sweep solution assisted Osmotic of RO (CSORO) or NF (CSONF) system that systematically reduces overall hydraulic pressure required to obtain product water from inlet diluted draw feed. The saline sweep solution (salinity equivalent to feed source) is fed at permeate compartment at a lower pressure than feed compartment pressure. FIG. 1 represents schematic diagram of counter-currently operated osmotic reverse osmosis system (the configuration can also be concurrently fed feed and saline sweep solution).

The scheme represented in dashed line describes overall operation wherein high saline feed stream 1 that requires to be concentrated is fed to the system of forward osmosis unit 2. Forward osmosis unit is separated by semi-permeable thin film composite (TFC) membrane made up of aromatic polyamide or cellulose triacetate (CTA) based membrane. The FO membrane allows separation of feed stream 1 and draw solution feed 3. Due to the action of naturally occurring osmosis process, feed water passes through FO membrane and dilutes the draw solution and leaves through the system 5. The concentrated feed or brine can be subjected to further concentration in subsequent FO unit or subsequently fed to thermal evaporator and crystallization unit for complete water removal and Zero Liquid Discharge (ZLD). The diluted draw solution stream 5 then passes through multiple array of counter current or con-current operated reverse osmosis system. The high pressure pumps 6, 8, 10 and correspondingly additional pumps according to number of RO stages pushes diluted draw solution to high concentration feed compartment of RO system 7, 9, 11 and correspondingly additional RO/NF stages respectively. For example in FIG. 1, three stage high pressure NF/RO stages are described. The highly concentrated draw solution leaves from final RO unit from stream 12 and contains draw solution concentration equivalent to initial feed concentration of FO unit to merge with stream 3 again. Occasionally some of the draw solution will be added to adjust the flow and concentration of feed draw solution concentration via stream 22.

The high osmotic pressure sweep solution can be either natural inorganic salt or synthetically made solution is counter currently or con-currently fed 18 with low pressure pump 19 to the permeate side 15 of last stage NF or RO unit. The preferred sweep solution are sodium ion based polyelectrolytes. The concentration of synthetic sweep solution is adjusted such that net osmotic pressure will be relative low corresponding to the concentration of feed side stream entering from previous NF or RO stage 9. This low net osmotic pressure eventually gives significantly lower hydraulic pressure applicable to pump 10. Upon application of hydraulic pressure corresponding to feed and sweep concentration, the net product water flow will be established across NF or RO membrane resulting in dilution of synthetic sweep solution feed and further concentration feed draw solution. The same methodology will be repeated in multiple stages to achieve treatment continuity and process conditions that are optimally operated.

The first stage will have the sweep solution leaving from the system 5 in a most diluted form. The concentration of sweep solution leaving 5 from the first stage is sufficiently low enough that can be treated by single-stage or multi-stage direct pass brackish water RO or sea water RO system. The permeate water 17 will have product water quality which is meeting WHO standards for drinking water conditions and the concentrate stream 18 is again fed back by low pressure pump 19 to last stage permeate compartment 15 of NF or RO process.

The entire system description described above from 1 to 22 comprises of one stage FO system that recovers product water 17 from feed stream 1 and further concentrates the feed depending on water recovery giving concentrated brine 4.

This invention discloses additional features of coupling additional FO systems that further concentrates the brine 4.

For example, in one specific scenario, the feed concentration from industrial wastewater effluent was subjected to two-stage FO system where feed was concentrated from 5% wt/wt salt to 13% wt/wt concentration.

After subsequent FO stages as described in FIG. 1, the concentrated brine from final stage 26 leaves FO units for further water recovery in downstream processes. Conventionally this is accomplished in a single or multistage thermal evaporator and crystallization units. However, this invention discloses novel method of incorporating membrane distillation unit for reject brine concentration together with multistage FO and counter current osmotic NF or RO system for draw solution recovery.

TABLE 1
Test results of single stage FO-CSORO configuration of various industrial wastewaters

| | | Feed | | | | Product | | | Concentrate | | | | Energy |
|---|---|---|---|---|---|---|---|---|---|---|---|---|---|
| | Process | | TDS, | COD, | TSS, | | TDS, | COD, | TDS, | Feed, | Output, | | Consumption, |
| Trial | Description | pH | mg/l | mg/l | mg/l | pH | mg/l | mg/l | mg/l | Litre/hr | Litre/hr | Recovery | kWh/m3 |
| Trial-I | FO + 2 Stage | 7.1 | 23,600 | 4198 | 430 | 6.5 | 300 | 163 | 86055 | 3000 | 2200 | 73% | 9.6 |
| | CSORO | | | | | | | | | | | | |
| Trial-II | FO + 2 Stage | 6.9 | 17,060 | 3715 | 854 | 6.81 | 315 | 206.4 | 55700 | 3000 | 2100 | 70% | 9.6 |
| | CSORO | | | | | | | | | | | | |
| Trial-III | FO + 3 Stage | 6.9 | 42,700 | 6501 | 1230 | 6.8 | 620 | 300 | 114554 | 3000 | 1900 | 63% | 11.3 |
| | CSORO | | | | | | | | | | | | |
| Trial-IV | FO + 3 Stage | 6.7 | 38,000 | 6200 | 1150 | 6.8 | 350 | 215 | 112977 | 3000 | 2050 | 66.66% | 11.3 |
| | CSORO | | | | | | | | | | | | |
| Trial-V | FO + 3 Stage | 6.7 | 41,400 | 5242 | 1060 | 6.8 | 352 | 165 | 111040 | 3000 | 1900 | 63% | 11.3 |
| | CSORO | | | | | | | | | | | | |
| Trial-VI | FO + 2 Stage | 6.7 | 48,000 | 6252 | 950 | 6.8 | 520 | 170 | 119250 | 3000 | 1800 | 60% | 11.3 |
| | CSORO | | | | | | | | | | | | |
| Trial-VII | FO + 3 Stage | 6.8 | 70,560 | 8348 | 2240 | 6.8 | 350 | 170 | 155650 | 3000 | 1800 | 60% | 11.3 |
| | CSORO | | | | | | | | | | | | |
| Trial-VIII | FO + 3 Stage | 6.8 | 54000 | 7800 | 780 | 6.3 | 200 | 210 | 135094 | 3000 | 1900 | 63% | 11.3 |
| | CSORO | | | | | | | | | | | | |

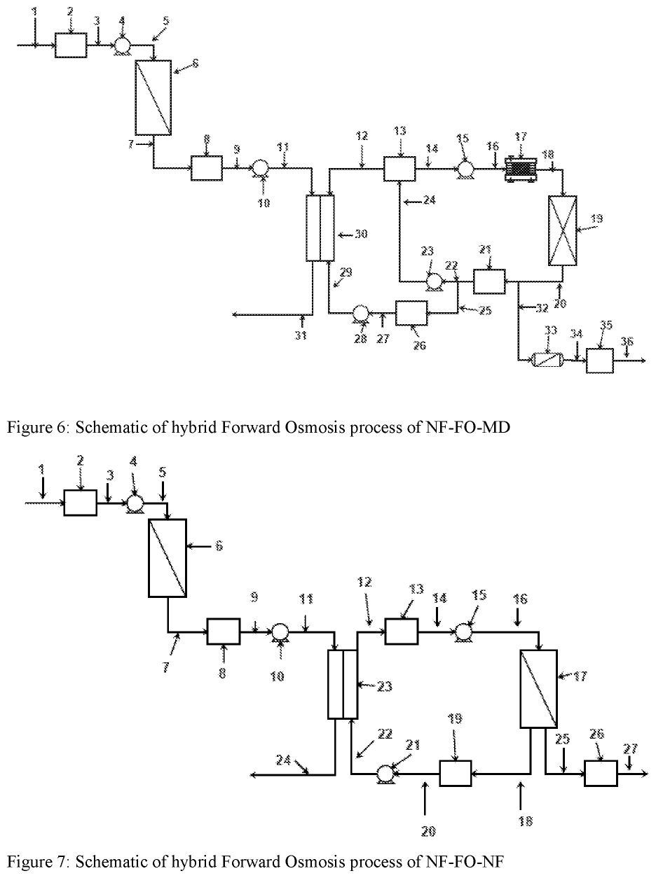

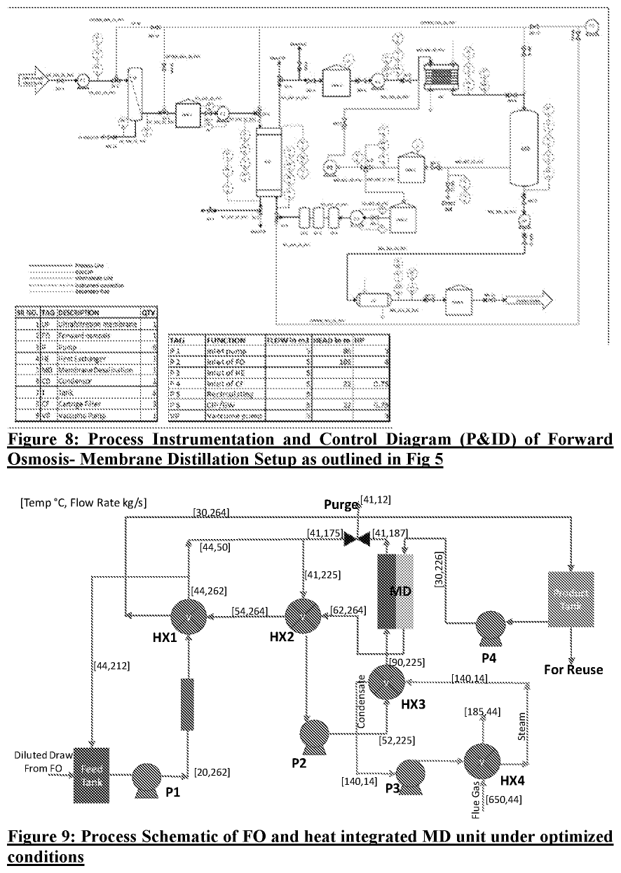

FIG. 5 represents system where very high salinity levels are in consideration particularly if TDS is higher than 130000 ppm range. Here the brine from multistage FO system 26 (FIG. 1) enters via 4 in subsequent Forward Osmosis-Membrane Distillation (MD) unit through tank 1 and pump 3, where draw solution stream containing product water (5) is being treated with custom-made membrane distillation unit (28). The diluted draw solution stream eventually passes through intermediate heat exchanger or heat pump which increases the temperature of the stream from ambient to 55-70° C. depending on which membrane distillation configuration was selected. More details on membrane distillation can be found elsewhere hi literature [8-10]. The product stream (12) from MD is passed through condenser (25) followed by collection in a product tank (26). The draw solution gets concentrated over time after recovery of substantial amount of product water. After desired increase in draw solution concentration, the draw solution is again fed back to FO system (22).

This way it is possible to concentrate the feed from 5% wt/wt to 20-25% wt/wt

Combinatorial Membrane Process

Although many tertiary treatment processes or zero liquid discharge solutions use Reverse Osmosis (RO) or nanofiltration (NF) to turn wastewater into recycled or reused water. However, higher salinity levels mean high energy requirement to overcome high osmotic pressure and high operating pressure of such pressure in pressure driven RO or NF process practically limit overall water recovery. Apart from limiting aspects from operation point of view, standalone RO and NF process also gives other maintenance issues such as high scaling and fouling propensity, expensive pumps and piping, frequent cleaning schedule and expensive cleaning chemicals usage.

There are very few ways to improve water recovery without affecting pressure requirement and overall system operation and maintenance costs. Hybrid FO system involves innovative FO membrane exploiting normal osmotic pressure to induce clean water flow from feed stream across the membrane in to the draw solution.

Depending on water quality, source and product water quality requirements, the draw solution recovery unit can be adjusted accordingly such as individual unit operations of RO (FO-RO), NF

(FO-NF), ultrafiltration (UF) (FO-UF), membrane distillation (MD) (FO-MD) or combination of these operations in different configurations such as FO-NF-RO, FO-NF-NF, NF-FO-RO, NF-FO-NF, NF-FO-MD, FO-NF-MD, NF-RO-UF etc., in the downstream section separates draw solution from product water. FO membrane is of cellulose acetate based hollow-fiber membrane module with systematic configuration to allow for co-current or counter-current operation mode. In order to maintain structural integrity of hollow fibers it is essential to keep positive pressure of 3 barg between shell-side and lumen-side of the fiber. Apart from that it is also important to maintain robust start-up and shut-down protocol to reduce pressure shock to hollow fiber membranes.

For RO or NF, commercially available membranes were chosen, which could be Dow Filmtec, Hydronautics, GE Osmonics, Toray or CSM. Depending on the solute concentration, product water requirement and draw solute selection, RO or NF membranes were chosen. In case it is essential to have high draw solute recovery due to cost-considerations, it is necessary to select high salt rejection membrane configuration. However, if it is necessary to recover as much product water, high water flux or high permeability membranes were chosen.

Table.2 shows schematic representation of hybrid Forward Osmosis system. The system consist of main FO unit combined with other unit process for the draw solution recovery i.e. nanofiltration (NF) and/or reverse osmosis (RO) and/or membrane distillation (MD) system. The recovery section process selection depends on many factors including the application of process, influent feed water quality, feed salinity, draw solute, resource constraint, concentrate disposal criteria etc.

Depending on salinity levels, different configurations for FO system are considered involving FO in combination with individual operations such as NF, RO or MD were implemented or alternatively for more complex system FO in combination with multiple draw solution recovery section are considered such as FO-NF-NF, FO-NF-RO, NF-FO-MD etc.

TABLE 2
Various hybrid FO process configuration depending on feed
water and application

| | | Treatment |
|---|---|---|
| TDS levels | Configurations | Application |
| 0-5000 | NF-FO-RO, FO-NF, FO-RO, | Brackish water, |
| | RO-FO-RO | ground water, |
| | | surface water, |
| | | industrial and |
| | | domestic wastewater |
| 5000-20000 | NF-FO-RO, FO-NF-RO, FO- | Brackish water, |
| | RO, FO-NF, FO-Multistage | seawater, highly |
| | Counter Current Osmotic | saline wastewater |
| | NF or RO | |
| 20000-40000 | FO-NF-RO, FO-MD, FO-NF- | Sea water, highly |
| | NF, FO-NF-RO, FO-NF, FO- | saline industrial |
| | Multistage Counter Current | wastewater |
| | Osmotic NF or RO | |
| >40000 | FO-NF-RO-MD, NF-FO-RO- | Highly saline |
| | MD, FO-NF-MD, FO- | industrial waste |
| | Multistage Counter Current | water |
| | Osmotic NF or RO | |

This invention describes the process to treat and recycle secondary treatment effluent of industrial wastewater. The pilot plant was bunt to test multiple configurations with “plug-and-play” approach with quick-fix piping, valves and pump system.

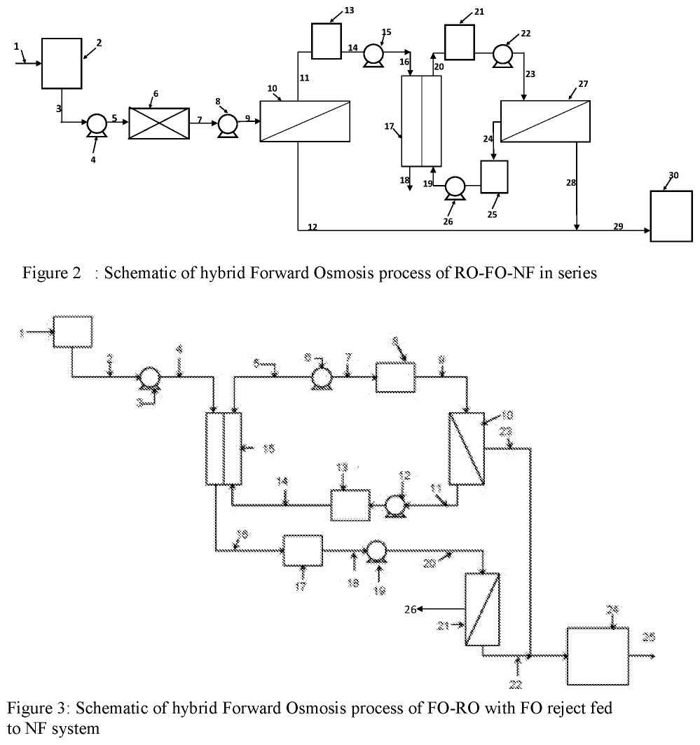

For example one the system which was tested was RO-FO-NF system in FIG. 2—involving hybrid FO (17) and RO (10) to recover water, along with NF (27) process to recover draw solution, is disclosed for treating and recycling industrial waste water for inlet water quality as follows: TDS 35000 ppm, COD 550 ppm, Total Hardness 1720 ppm, TSS 120 ppm.

The process involves wastewater feed stream (1) entering into feed tank (2) followed by treating it with pretreatment unit operations involving multimedia filters (MMF) and ultrafiltration (6) fed to it by pump (4). After MMF and UF, the stream is fed to RO unit (10) at 40-60 Barg pressure using high pressure pump (8). Pressure pushes water through the membrane towards permeate side and leaves the system via 12 and 29 to product water tank 30. The RO system gives 30-50% water recovery.

Untreated and 50-70% rejected water from untreated retentate side leaves the RO system via 11 and fed to tank 13. The rejected water will eventually be pumped by 14 and enters forward osmosis unit 17 via 16. Forward osmosis unit is mainly hollow fiber membrane module which operates in a counter-current mode. The concentrated draw solution is fed (19) to bore side (inside part) of the hollow fiber and feed stream (16) stays in shell-side (outside part) of the module. In order to achieve stable operation, it is essential to keep bore side pressure lower than the shell side of the stream.

Due to the concentration difference between feed and draw solution, water transport through the shell-side to the bore-side of the module and leaves from the end port. FO system concentrates the feed stream and retained constituents with remaining water leaves the FO system (18) for disposal. FO system recovers 50-75% of water from feed stream to draw solution stream.

Diluted draw solution stream (20) leaves the FO system to tank 21 which subsequently been pumped via 22 to nanofiltration module 27. In nanofiltration module (27), zwitterion containing draw solution is separated from product water and leaves via stream 24 to tank 25. Potable water from the NF permeate side is sent to tank 30 via 28 and 29.

Zwitterion containing draw solution is again recycle back after providing desired replenishment to FO unit 17 via pump 26 and stream 19.

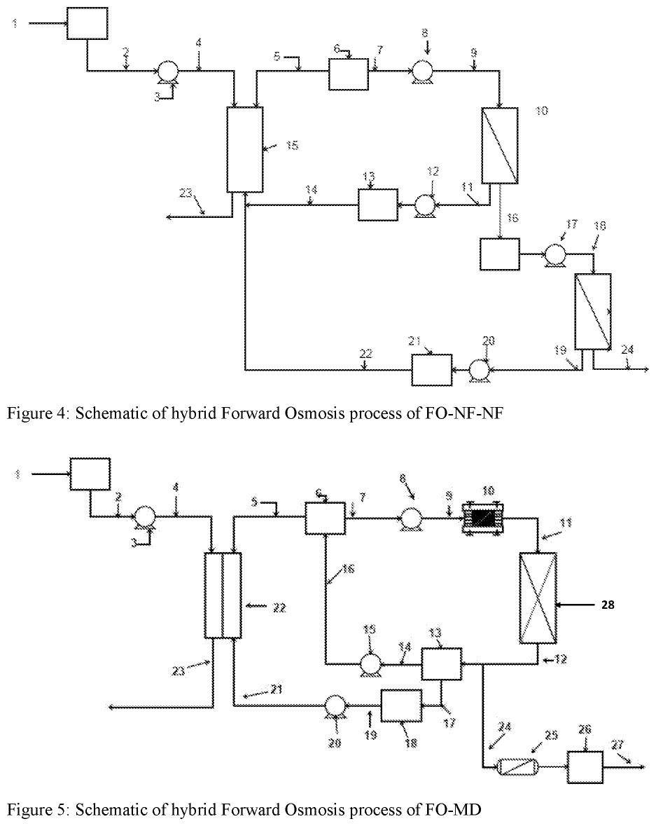

Other hybrid FO process configuration were described in the following sections. In FIG. 3, in comparison with system shown in FIG. 2, the concentrate or reject from FO (15) is being fed to NF system (21) where the product water eventually gets collected in product water tank (24) and the reject stream gets discarded (26). This system of FO reject recycle could be interesting for wastewater source where multivalent ion concentration was extremely high. FIG. 4 represents system where extremely high salinity levels are in consideration particularly if TDS is higher than 40000-50000 ppm range. Here FO product stream (or diluted draw solution stream) (5) is being treated with first stage NF system (10). The product stream (16) from 1st stage NF is collected in intermediate tank (16), which eventually is sent to 2nd stage NF system via 18. The product is eventually collected via 24. The reject from the 1st stage (11) is concentrated draw solution which is again fed back to FO system (15). Here for the test cases, 1st stage NF was considered as open, less fight, high permeate flow NF membrane which could be Dow Filmtec NF270 or Hydranautics NANO-SW membranes which in the 2nd stage the membrane could be fight, high salt rejection membrane such as Dow Filmtec NF90.

FIG. 8 represents detailed instrumentation and control diagram of system described in FIG. 5 wherein very high salinity levels are in consideration particularly if TDS is higher than 50000 ppm range. Here FO product stream (or diluted draw solution stream) (5) is being treated with custom-made membrane distillation unit (28). The diluted draw solution stream eventually passes through intermediate heat exchanger which increases the temperature of the stream from ambient to 55-70° C. depending on which membrane distillation configuration was selected. The membrane distillation (MD) unit is made up of hydrophobic ePTFE or PVDF hollow fiber membrane. The water contact angle of ePTFE membrane is around 125° and PVDF is around 110°.

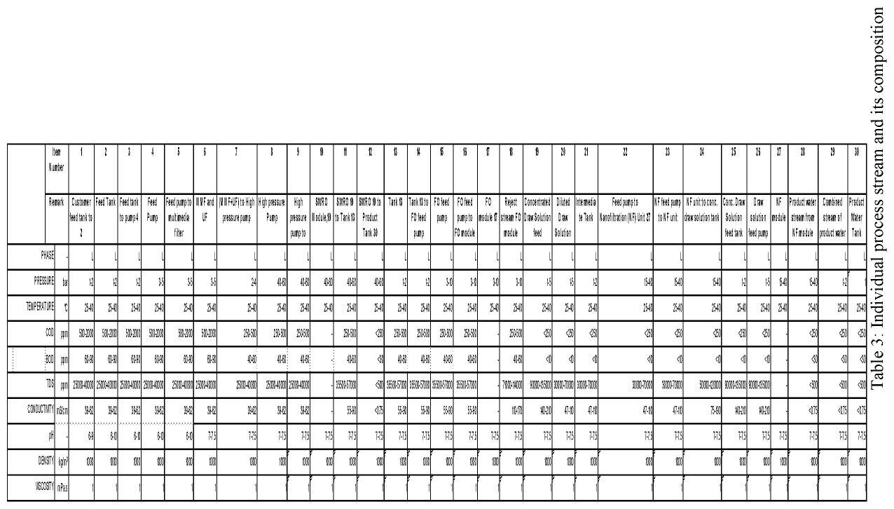

The product stream (12) from MD is passed through condenser (25) followed by collection in a product tank (26). The draw solution gets concentrated over time after recovery of substantial amount of product water. After desired increase in draw solution concentration, the draw solution is again fed back to FO system (22). Draw solution recovery with MD system can be combined with array of heat exchangers as showcased in FIG. 9 so that the effective heat integration provides most optimal energy consumption to produce unit volume of product water.

FIG. 6 is somewhat similar to system shown in FIG. 4 however, if the inlet water stream contains high multivalent components or hardness precursors, it is advisable to initially pass the wastewater stream to primary NF system (6). Few applications have been successfully tested for FIG. 5 configuration including concentration of sodium Sulphate, calcium chloride solution from 3-5 wt % to 25-27 wt %.

FIG. 7 can be implemented for industrial wastewater or seawater where the first stage NF (6) removes hardness components including undesirable multivalent ions. Remaining system stays similar to what was described in previous schemes where diluted draw solution (12) containing product water is subjected to NF operation (17). Product water is collected in tank 26 and recovered draw solution (18) is sent back to draw solution feed tank (19). Several applications have been tested such as sea water desalination, municipal wastewater treatment and recycle, industrial wastewater recycle and reuse.

The details of process and operating parameters for respective unit operation, stream and units are expressed in Table 2.

The feasibility studies have been conducted to identify practical and operational limitations of the plant. The Design of Experiment (DOE) matrix was performed in order to identify the optimized conditions. The three-Factor DOE was tested involving feed TDS, transmembrane pressure and draw solution composition.

There are number of responses to be observed in above DOE namely water flux, fouling tendency, reverse salt flux, energy consumption etc.

The DOE is mentioned below:

| Factor Name | Letter | Setting 1 | Setting 2 |
|---|---|---|---|
| Feed TDS, ppm | A | 5000 | 90000 |
| Feed Flow Rate, | B | 1 | 4 |
| m3/hr | | | |
| Draw Solution | C | 150000 | 270000 |
| Concentration, ppm | | | |

FIG. 8: Process Instrumentation and Control Diagram (P&ID) of Forward Osmosis-Membrane Distillation Setup as outlined in FIG. 5

FIG. 9: Process Schematic of FO and heat integrated MD unit under optimized conditions

The pilot plant of 20,000 m3/day capacity has been successfully tested for continuous 5000 hours combining Forward Osmosis-CSORO-MD system provides valuable results in terms of process performance, water flux, membrane fouling, reverse solute flux, scaling etc.

This invention has showcased effective combination of conventional processes such as NF, RO, CSONF, CSORO or MD with novel FO process that is suitable to treat high-salinity water. With modular and scalable system, it may even be possible to fine-tune the system based on feed water quality and application. Such approach would reduce the costs related to pretreatment, membrane life, chemical cleaning, reduced piping and overall reduced maintenance. Further, operating costs of wastewater recycling using processes mentioned in this invention work has been reduced up to 50%.

The process for treating and recycling water source which can be industrial, household, seawater, food & beverage, pharmaceuticals or any source which requires dewatering or concentration of feed and extraction of product water using single or multistage forward osmosis with any combination of single or multistage reverse osmosis, nanofiltration, membrane distillation in series or parallel configuration for draw solution recovery. Such system would be called FO system

1. A Hybrid Membrane-based processes for dewatering, concentration, solvent separation, extraction, purification or filtration applications of different liquid feed sources consists with single or multistage forward osmosis with any combination of single or multistage reverse osmosis (RO), nanofiltration (NF), membrane distillation (MD) in series or parallel configuration for draw solution regeneration and product water recovery;
Wherein product of FO is fed to single or multistage high pressure direct pass NF unit;
Wherein product of FO is fed to single or multistage high pressure direct pass brine water RO (BWRO) unit;
Wherein product of FO is fed to single or multistage high pressure direct pass sea water RO (SWRO) unit;
Wherein product of FO is fed to single or multistage NF followed by multistage high pressure BWRO or SWRO combinatorial units;
Wherein product of FO is fed to single or multistage high pressure BWRO and SWRO combinatorial unit;
Wherein reject or concentrate of single stage FO unit is fed to subsequent single or multistage FO unit with subsequent single or multistage high pressure direct pass NF or BWRO or SWRO units in a combinatorial units;
Wherein feed to FO is subjected to prior pre-treatment stages of Membrane Bioreactor (MBR), pressure sand filters (PSF), activated carbon (AC) adsorption, micron cartridge filters, ultrafiltration (UF) units

2. A water treatment method comprising of Source feed liquid which is any of the following: sea water, brackish water, industrial wastewater, impaired water, domestic household wastewater, reverse osmosis brine, membrane filtration concentrates, food & beverage based wastewater, fruits juices, milk whey, any liquid or solvent systems that requires to be dewatered, purified, separated, fextracted, fractionated or concentrated;
Wherein single stage or multistage forward osmosis membrane comprising of aromatic polyamide based thin film composite (TFC) or cellulose triacetate (CTA) semi permeable membrane capable enough to dewater or concentrate source liquid;
Wherein single stage or multistage forward osmosis membrane of hollow fiber or spiral wound flat sheet configuration
Source feed liquid having certain solute and solvent concentration and corresponding osmotic pressure and the second feed solution stream “draw solution” having specific solutes and solute concentration;
Wherein passing an inlet feed source of solute-solvent stream through naturally occurring low pressure forward osmosis membrane system while draw solution on permeate side of forward osmosis membrane system as described in claim 1
Wherein passing the product water containing diluted draw solution from FO unit is then passed through multistage pressurized Counter-currently (or Co-currently) fed Sweep Solution assisted Osmotic RO (CSORO) or NF (CSONF) or in their combinatorial arrangement at their feed compartment through high pressure pump system to produce pressurized concentrated draw solution stream at the last stage of CSORO or CSONF or their combinatorial system
Wherein low pressure sweep solution containing specific solutes and solute concentration having similar or lower osmotic pressure than the feed, passing counter currently or concurrently through permeate compartment of single stage or multistage CSONF or CSORO or their combinatorial system, to produce low salinity desalinated product water stream at the last stage of CSORO or CSONF or their combinatorial system
Wherein the equipment configuration and the methodology for CSORO or CSONF system are adjusted accordingly to exhibit sufficient osmotic pressure differential between feed compartment and permeate compartment so that solvent or water passes from the BWRO or SWRO or NF or their combinatorial membrane system
Wherein passing the concentrate from first stage CSONF or CSORO through high pressure booster pump in to the second stage while low pressure osmotic sweep solution passing through permeate side of the membrane resulting even more concentrated reject brine and even more diluted sweep solution in a counter-currently or co-currently fed manner
Wherein repeating the methodology of osmotically enhanced CSORO or CSONF or their combinations in a pressurized feed or concentrated compartment through high pressure pump and low pressure sweep solution passing through CSORO or CSONF permeate compartment in a counter current or concurrent mode until desired terminal stage draw solution concentration is achieved
Wherein highly concentrated draw solution from terminal stage of CSONF or CSORO or their combinatorial system returns back to Forward Osmosis draw solution feed
Wherein diluted sweep solution after recovering product water from draw solution having significantly lower concentration or osmotic pressure from terminal stage of osmotically enhanced CSONF or CSORO or their combinatorial system passes through single or multistage direct pass high pressure NF or BWRO or SWRO membrane systems producing permeate water having product water quality meeting WHO standards of less than 500 ppm TDS
Wherein concentrated reject or brine emerging from direct pass single of multistage NF or BWRO or SWRO membrane system returns to first stage of low pressure permeate compartment of CSONF or CSORO
Wherein FO and single or multistage CSORO or CSONF or their combinatorial system uses draw solution of inorganic salts and preferably magnesium chloride, calcium chloride, sodium chloride, potassium chloride, ammonium chloride, sodium sulphate, magnesium sulphate etc.
Wherein FO and single or multistage CSORO or CSONF or their combinatorial system uses draw solution of organic compounds, preferably sodium salt of EDTA, glucose, sucrose, fructose, fatty acid, glycol, organic salts, fertilizers
Wherein FO and single or multistage CSORO or CSONF or their combinatorial system uses draw solution of synthetically made molecules such as sodium polyacrylates dendrimers, polymer hydrogel, ammonia-carbon dioxide, thermosensitive polyelectrolytes, switchable polarity solvents, zwitterions (i.e. glycine, L-proline, glycine betaine) etc.

3. A Membrane Distillation (MD) unit for further concentration of feed to the concentration near saturation levels of salts;
(a) In the process of claim 1, wherein further draw solution regeneration from FO product is fed to MD unit;
(b) In the process of claim 2, wherein concentrated draw solution from multistage CSONF or CSORO unit of FO system is fed to MD unit
(c) In the process of claim 1 and claim 2, wherein concentrated brine or reject stream of single of multistage FO system passes through single or multistage MD unit
(d) In the process of claim 1 and claim 2, where concentrated brine or reject from FO system gets further concentrated up to 20-25% wt/wt of salt concentration
(e) The concentrated brine from MD system then subjected to thermal evaporation unit of multistage evaporators and crystallization units
(f) Wherein MD membrane unit is made of hydrophobic ePTFE, PP or PVDF hollow fiber membrane and operated under either Direct Contact Membrane Distillation (DCMD) or Vacuum assisted Membrane Distillation (VMD) and achieves salt concentration up to 18-25% wt/wt
(g) Comprises of arrays of heat exchanger, MD unit, feed pumps, vacuum pump (for VMD) and condenser unit to achieve desired levels of product water quality and quantity, brine concentration and minimization and energy efficiency
(h) MD feed heated up to 55-70° C. before being fed to MD unit.
(i) Saline feed water stays outside of hydrophobic pore and does not wet the internal structure of the membrane. The water vapor passes though the hydrophobic pores of the membrane and condenses on condenser or chiller part at or after permeate compartment
(j) concentrate from MD is recirculated back to FO unit
(k) concentrate from draw solution recovery of NF, RO, CSORO or CSONF is fed to MD unit
(l) MD unit can be externally mounted in series or parallel and fed through external pump systems and feed solution is fed to shell side of the membrane and product water is recovered from bore or lumen side of the membrane
(m) MD unit as a submerged unit placed directly into saline medium and saline medium is constantly circulated through external heat exchanger system

4. The process of claim 1, wherein pressure difference across the FO, NF, RO, CSORO, CSONF membranes adjusted for stable operation and to obtain desired water flux.

5. The process of claim 1, wherein draw solution constituent, concentration and flow are adjusted and optimized to achieve desired water flux

6. The process of claim 1, wherein source feed flow is adjusted and optimized to allow desirable residence time

7. The method of claim 2 wherein the draw solution is fed to osmotically enhanced CSONF or CSORO or their combinatorial system to recover draw solute and separate product water.

8. The process of claim 3, wherein heat exchangers and condensers are arranged in specific combinations for source feed and source heat to achieve maximum heat efficiency at lower capital and operation investment
